(19) United States
(12) Patent Application Publication
(10) Pub. No.: US 2009/0093743 A1
(43) Pub. Date: Apr. 9, 2009

(54) Versatile back treatment implement system

(76) Inventor: Jean P. Corzine, Fort Myers, FL (US)

Correspondence Address: Jean P. Corzine, 9036 Cypress Dr. S., Fort Myers, FL, 33967, US

(21) Appl. No.: 11/973,096

(22) Filed: Oct. 9, 2007

(51) Int. Cl. A61H 7/00; A61H 19/00

(52) U.S. Cl. 601/136; 601/134; 601/84

(57) ABSTRACT

The invention pertains to a versatile back treatment implement system that consists of different implements that can be interchangeably used. Any one of the implements can be a lotion applying implement, a brush implement or a massaging implement. A handle has at one end thereof of friction grip handle and at another end an attaching system that can interchangeably attach any one of the various implements. The interchangeability also includes various elements that allow any one of the implements to be used in a rigid manner on the back of a person in a pivotal manner or in a manner where any one of the implements can change to different directions of movements simply by tuning the friction grip handle. The handle can also be adjusted to different lengths.

### BACKGROUND OF THE INVENTION

There are many back treatment implements known and available and they include lotion applicators that have removable and/or washable applicator sheets thereon. Some are known to have telescoping handles thereon that will adjust to different lengths for differently sized persons. Then, there are known back scrubbers and back massagers. Some implements are known where the applicator end can pivot relative to the length of the handle.

### BRIEF DESCRIPTION OF THE INVENTION

The inventive concept of the back treatment implement includes the ability of a person to convert the back treatment implement to various treatment procedures, such as, lotion application, back scrubbing or a massage procedure. The implement also has a way of turning any of the implements in different directions. The implements may be of a rectangular shape, but the direction of the rectangle can be turned in an up and down direction or in a horizontal direction. This assures that the various contours of the surface of the human back can be equally treated. The lotion applicator has an application sheet thereon that can be discarded for a new one or it can be washed.

### BRIEF DESCRIPTION OF THE DRAWINGS

FIG. 1 shows the overall back treatment implement;

FIG. 2 illustrates a rotating connection between various elements;

FIG. 3 shows a removable implement from the handle;

FIG. 4 shows an implement in the form of a brush with bristles;

FIG. 5 illustrates a massaging implement;

FIG. 6 shows a universal joint between the handle and an implement;

FIG. 7 shows a pivotal joint;

FIG. 8 shows how a removable implement from the handle;

FIG. 9 illustrates a massaging implement with attaching threads;

FIG. 10 illustrates a brush implement with attaching threads.

### DETAILED DESCRIPTION OF THE INVENTION

FIG. 1 illustrates the overall back treatment implement 1 which consists of a handle having parts 2, 3 and 4 that are telescoping within each other to shorten or lengthen the handle when desired. Taller persons desire to have a longer handle. Also any person using the treatment implement may choose to only use the implement on an upper area of the back whereby a shorter handle may be desired. The part 2 of the handle 1 has a friction grip surface thereon which may come in handy when the handle 1 is to be rotated the purpose of which will be explained below. The front end of handle 1 has a rounded head 5 which has a depending socket 5a thereon. The depending socket 5a is so constructed that various treatment elements may be interchanged, again, as will be explained below. All interchangeable treatment elements have a back up plate 6 as shown in FIG. 1.

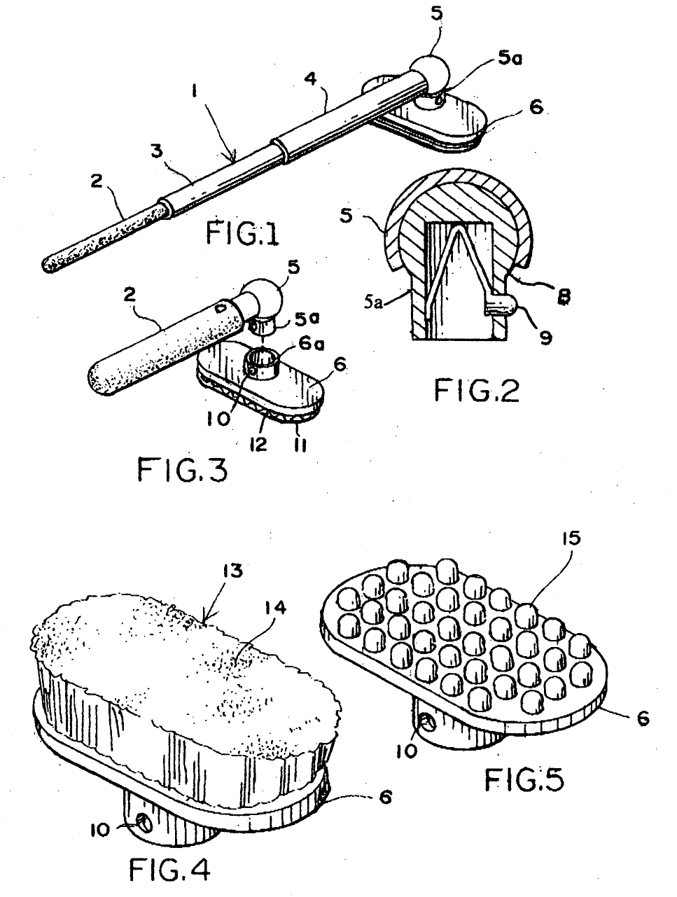

FIG. 2 illustrates a rotating joint 8 which is contained within the rounded head 5. The rotating joint 8 has the depending socket 5a thereon. The depending socket 5a is hollow and has the spring loaded button 9 extending there from. The spring loaded button 9 will be explained below.

FIG. 3 shows the handle 1 in its collapsed condition whereby only the friction handle 2 is shown. Again, this FIG. 3 shows a rounded forward head 5 which has the depending socket 5a thereon. The depending socket in this embodiment is a cylindrical element which will fit into a cylindrical socket 6a on the base plate 6. There is a snap-fit connection between the depending socket 5a and the cylindrical socket 5a consisting of a ball 9 under spring pressure (FIG. 2) and a reception hole 10 on the cylindrical socket 6a. Such removable connections are well known.

FIG. 3 further shows the back-up plate 6 having a removable lotion applying piece of fabric as a layer 11 attached thereto. The layer 11 is kept in its place by way of a hook and loop (VELCRO) fastening system 12 which is attached with its hook system to the underside of the back-up plate 6. There are many other ways of attaching the lotion applying sheet to the underside of the back-up plate 6 such snap fasteners etc., although the hook and loop fastening system is preferred because of its simplicity. The lotion applying sheet can consist of different materials such a sponge material, terry cloth or non-woven material.

FIG. 4 illustrates another back treatment implement 14 by way of a brush having bristles 13 thereon. This implement is useful in scrubbing the back of a person when taken a bath. Notice the attachment feature 10 by way of a hole 10 to receive the spring ball 9 therein.

FIG. 5 illustrates still another back treatment implement by way of a massaging unit. The massaging unit has nubs or knobs 15 thereon which may be made of rubber or plastic and when made of rubber, knobs 15 may be somewhat flexible to follow the contour of the person's back or to enhance the massaging effect of the implement. Notice the attachment feature 10.

FIG. 7 illustrates a different way of attaching different ones of the various implements to the handle 1. In this embodiment, there is the rounded forward end 5 of the handle which has a threaded socket 16 depending therefrom. The depending threaded socket 16 is mounted to the rounded forward end 5 by way of a pivot 17. This way, when the massage implement is being used, the basic back-up plate 6 will move or pivot in a vertical plane when the implement is in use.

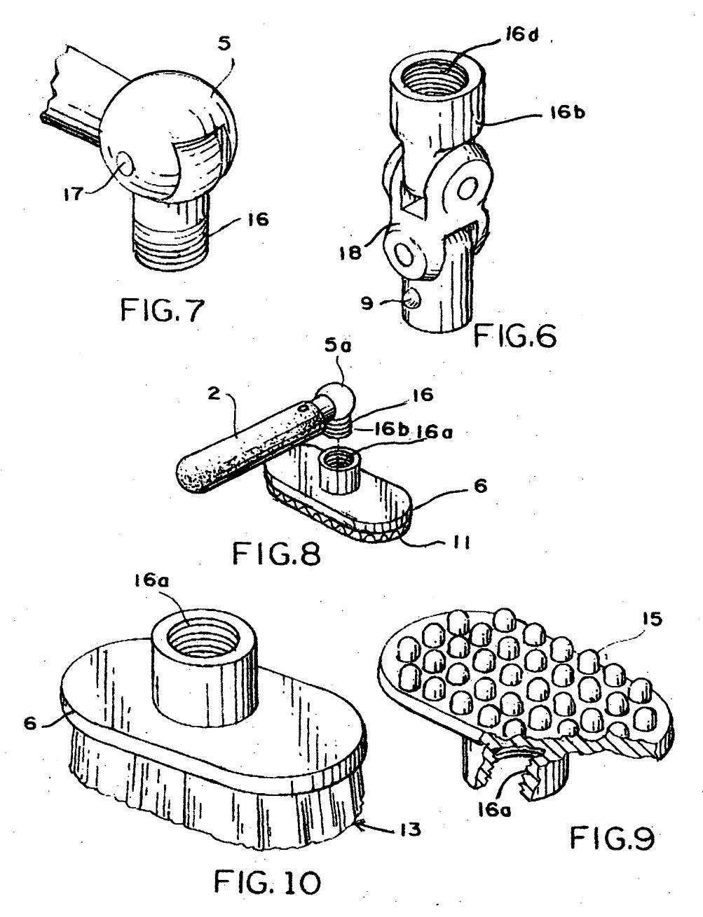

FIG. 6 shows still a more versatile movement connection of the base plate 6 relative to the handle 1. This embodiment involves a universal joint 18. This universal joint 18 may by attached to the handle in many different ways. One way is shown by the cylindrical socket 16a which has interior threads 16d therein (see FIG. 8). The cylindrical socket 16b can now be attached by way of the screw threads to the depending socket 16 (FIG. 8) The bottom end of this universal joint 18 can have threads 16 thereon (FIG. 7) which can be screwed into any of the various implements into the socket marked 16a or the fastening system shown in FIG. 2 can be used. See the reference character 9 on the universal joint 18. The use of a universal joint enables the person to use any of the various implements in many different modes or directions of movement. By simply turning the handle 1 by way of the hand grip 2, the implement on the back of a person can be turned in many directions. That is, horizontally, vertically or diagonally. The mode of use depends solely on the wishes of the user. The back of a person has many different surface contours and the use of a universal joint enables the person to accommodate the many different contours.

FIG. 8 shows a shortened handle 1 and shows how the various and different implements can be attached to the handle 1 by screw threads. The depending socket 16 has screw threads 16b thereon which can be matched with the interior screw threads of the cylindrical socket 16a.

FIG. 9 illustrates the same implement that was shown in FIG. 5 with the exception that this implement is used for a massage procedure and is fastened to the handle 1 by way of the interior screw threads 16a as was explained with regard to FIG. 8.

FIG. 10 is a showing of a brush implement that is fastened to the depending socket 16b to the interior threads 16a in the upstanding cylindrical socket located on the base plate 6.

What I claim is:

1. A versatile back treating implement system comprising a handle having on one end thereof a hand grip and on another end thereof having a means for changeably attaching various back treating implements thereon.

2. The versatile back treatment implement system of claim 1, wherein the various back treatment implements are selected from the group of back treatment implements consisting of a lotion applying implement, a back brushing implement and a back massaging implement.

3. The versatile back treatment implement system of claim 1, wherein said means for changeably attaching said various back treatment implements has means thereon for rigidly attaching any one of said various implements.

4. The versatile back treatment implement system of claim 1, wherein said means for attaching said various back treatment implements has means thereon for moveably attaching any one of said various implements to be able to move in a plane of a vertical direction.

5. The versatile back treatment implement system of claim 1, wherein said means for attaching said various back treatment implements has means thereon for moving any one of said implements in all directions.

6. The versatile back treatment implement system of claim 5, wherein said means for moving in all directions includes a universal joint.

7. The versatile back treatment implement system of claim 2, wherein said lotion applying implement includes a lotion applying material which is removably attached to a base plate of said implement.

8. The versatile back treatment implement system of claim 2, wherein said brush implement includes bristles.

9. The versatile back treatment implement system of claim 2, wherein said massage implement has knobs therein.

10. The versatile back treatment implement system of claim 9, wherein said knobs are flexible.

11. The versatile back treatment implement system of claim 1, wherein said handle can be extended to different lengths.
